(19) United States
(12) Patent Application Publication
(10) Pub. No.: US 2022/0122366 A1
(43) Pub. Date: Apr. 21, 2022

(54) ELECTRICAL PRODUCT MANAGEMENT SYSTEM

(71) Applicant: NEC Corporation, Minato-ku, Tokyo (JP)

(72) Inventors: Rui ISHIYAMA, Tokyo (JP); Toru TAKAHASHI, Tokyo (JP); Yuta KUDO, Tokyo (JP)

(73) Assignee: NEC Corporation, Minato-ku, Tokyo (JP)

(21) Appl. No.: 17/422,652

(22) PCT Filed: Jan. 29, 2019
(86) PCT No.: PCT/JP2019/002994

§ 371 Date: Jul. 13, 2021

(51) Int. Cl. G06V 20/80; G06T 7/00; G06Q 10/00

(52) U.S. Cl. CPC G06V 20/80; G06Q 10/20; G06T 7/0006

(57) ABSTRACT

An electrical product management system identifying and managing an individual electrical product includes a camera and a management device. The camera is configured to acquire an image of a surface of at least one blade of a plurality of blades included by a power plug of the electrical product. The management device is configured to authenticate the individual electrical product based on the image acquired by the camera.

### TECHNICAL FIELD

The present invention relates to a management system, management method, recording medium and adapter device for an electrical product.

### BACKGROUND ART

Some systems that manage electrical products have been proposed.

For example, Patent Document 1 describes an electrical appliance management technique for finely managing energy usage, operation time and so on for each electrical appliance without the need for complicated processing. To be specific, it is described that: when a home electrical appliance or the like whose plug is equipped with a wireless chip having a unique wireless chip number is plugged in an information outlet, the wireless chip number and the number of the information outlet are transmitted to a home server; when energy consumption does not change anymore because, for example, the plug is pulled out of the information outlet, a power counter and a time counter are recorded on the home server based on the wireless chip number; when a predetermined energy usage or operation time is reached, replacement of a maintenance part or the like of the home electrical appliance is prompted from the home server; and, after the homer server is logged in from outside to check the status, the power supply of the information outlet to which a home electrical appliance or the like that can be disconnected without any problem is broken by remote operation.

Further, Patent Document 2 describes a power plug, a power outlet, a tag management device, and a power supply system that enables power supply for value even to an electrical equipment that does not have a communication function. To be specific, it is described that: a power plug having an IC tag in which a user ID is stored, a power outlet in which the power plug can be inserted and which has a tag reader acquiring the user ID stored in the IC tag of the power plug, and a tag management device that determines whether the user ID acquired by the power outlet from the power plug is registered in a tag database and, when determining that the user ID is registered in the tag database, sends out information according to the determination result toward the power outlet are included; and when the power plug is inserted into the power outlet, power is supplied to an electrical equipment via the power outlet and the power plug in accordance with the user ID of the IC tag.
Patent Document 1: Japanese Unexamined Patent Application Publication JP-A 2004-056435
Patent Document 2: Japanese Unexamined Patent Application Publication JP-A 2006-244818

However, the abovementioned systems that manage electrical products need a power plug to be provided with a wireless chip which has a unique wireless chip number or an IC tag in which a user ID is stored, which are costly.

### SUMMARY

An object of the present invention is to provide an electrical product management system which solves the abovementioned problem.

An electrical product management system according to an aspect of the present invention is an electrical product management system identifying and managing an individual electrical product. The electrical product management system includes: a camera configured to acquire an image of a surface of at least one blade of a plurality of blades included by a power plug of the electrical product; and a management device configured to authenticate the individual electrical product based on the image.

An electrical product management method according to another aspect of the present invention is an electrical product management method for identifying and managing an individual electrical product. The electrical product management method includes: acquiring an image of a surface of at least one blade of a plurality of blades included by a power plug of the electrical product; and authenticating the individual electrical product based on the image.

On a non-transitory computer-readable recording medium according to another aspect of the present invention, a program is recorded. The program includes instructions for causing a computer identifying and managing an individual electrical product to execute: a process of acquiring an image of a surface of at least one blade of a plurality of blades included by a power plug of the electrical product; and a process of authenticating the individual electrical product based on the image.

An adapter device according to another aspect of the present invention includes: an adaptor body including a plurality of insertion ports in which a plurality of blades included by a power plug of an electrical product are inserted, an opening for attaching a camera, and a chamber communicating with the insertion ports and the opening; and a light source installed in the chamber and configured to emit light to a position in which a predetermined site of one blade of the plurality of blades fully inserted into the plurality of insertion ports is located.

With the configurations described above, the present invention can reduce the cost for identification and management of electrical products.

### BRIEF DESCRIPTION OF DRAWINGS

FIG. 1 is a view showing a schematic configuration of an electrical product management system according to an example embodiment of the present invention;

FIG. 2 is an external perspective view showing an example of a power plug;

FIG. 3A is an external perspective view showing an example of an adapter;

FIG. 3B is a view of the adapter seen from a side on which an opening is formed;

FIG. 3C is a cross-section view showing an example of an internal structure of the adapter;

FIG. 4 is a block diagram showing an example of a configuration of a management device;

FIG. 5 is a view showing an example of data stored in a database;

FIG. 6 is a flowchart showing an example of a procedure for previously registering data relating to an individual electrical product to be rented into the database;

FIG. 7 is a flowchart showing an example of a procedure for recording data relating to rental and return of an electrical product in the database and managing the product;

FIG. 8 is a flowchart showing an example of a procedure for recording data relating to maintenance of an electrical product in the database and managing the product;

FIG. 9 is an external perspective view showing another example of the configuration of the adapter;

FIG. 10A is a plan view showing a configuration example of a power outlet used in the electrical product management system of the present invention;

FIG. 10B is a cross-section view showing an example of an internal structure of the power outlet used in the electrical product management system of the present invention; and

FIG. 11 is a block diagram of an electrical product management system according to another example embodiment of the present invention.

### EXAMPLE EMBODIMENTS

### First Example Embodiment

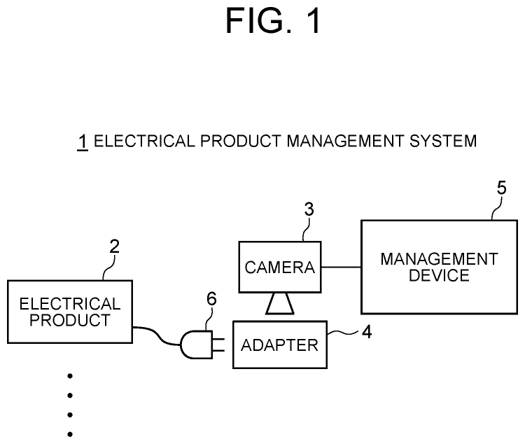

FIG. 1 shows a schematic configuration of an electrical product management system 1 according to a first example embodiment of the present invention. The electrical product management system 1 manages an electrical product 2 rented out to and used in a general household or the like. The electrical product management system 1 includes a camera 3, an adapter 4, and a management device 5.

The camera 3 is a device that acquires an image of a blade of a power plug 6 of the electrical product 2. As the camera 3, for example, a camera incorporated in a smartphone can be used. However, the camera 3 is not limited thereto, and may be any digital camera. The adapter 4 is an image capture aid attached to the camera 3 at the time of acquiring an image of the blade of the power plug 6. The management device 5 is a device that authenticates the individual electrical product 2 based on the acquired image, stores various information of the electrical product 2 in association with the image, and manages the product.

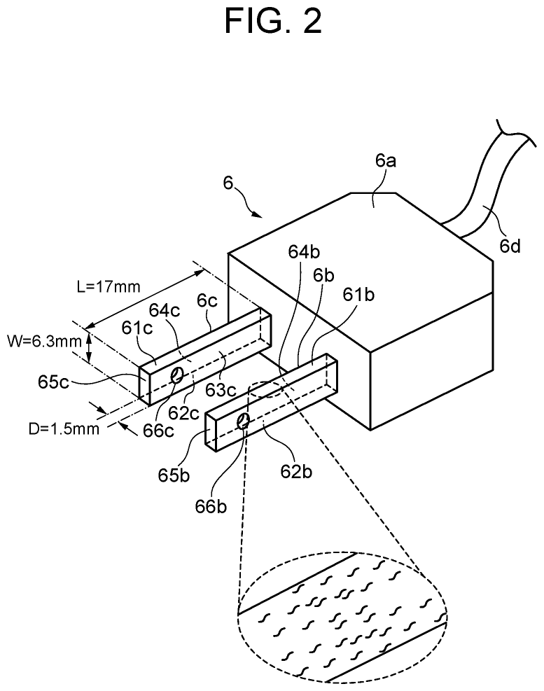

FIG. 2 is an external perspective view showing an example of the power plug 6. The power plug 6 in this example is a flat blade type having no distinction between polarities. The power plug 6 has a plug body 6a, a pair of blades 6b and 6c protruding from a front end face of the plug body 6a, and a power cord 6d pulled out from a rear end face of the plug body 6a and connected to the body of the electrical product 2. The pair of blades 6b and 6c are conductive in the plug body 6a with a pair of electric wires (not shown) provided in the power cord 6d. The blades 6b and 6c are also called electrodes, insertion blades, or plug blades.

The blades 6b and 6c are made of a conductive metal. The blades 6b and 6c are shaped like a flat plate in the case of a flat blade type power plug, and have predetermined dimensions. To be specific, in the case of a flat blade type power plug having no distinction between polarities, the blades 6b and 6c have the same dimensions, where a length L from the root to the tip of the blade is 17 mm, a width W of the blade is 6.3 mm, and a thickness D of the blade is 1.5 mm. At positions of 11.7 mm from the roots of the blades 6b and 6c, blade holding holes 66b and 66c are formed. Hereinafter, the respective faces of the blades 6b and 6c will be denoted by reference numerals 61b, 62b, 63b, 64b, 65b, 61c, 62c, 63c, 64c and 65d for distinction as shown in FIG. 2.

On the surfaces of the blades 6b and 6c as described above, as schematically shown in a broken line circle in FIG. 2, fine irregularities are spontaneously formed during a blade manufacturing process. The patterns of the fine irregularities are slightly different for each power plug 6, for each blade of one power plug 6, and for each blade portion of one blade. For example, the patterns of the fine irregularities have periods of micrometers to millimeters, which are different for each blade or the like. In this example embodiment, the pattern of spontaneously occurring fine irregularities generated in the manufacturing process is captured by the camera 3 and used as an identifier that uniquely identifies the individual electrical product 2.

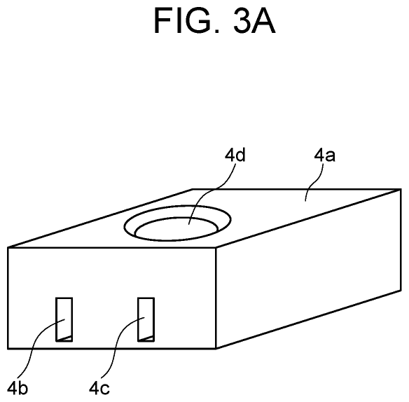

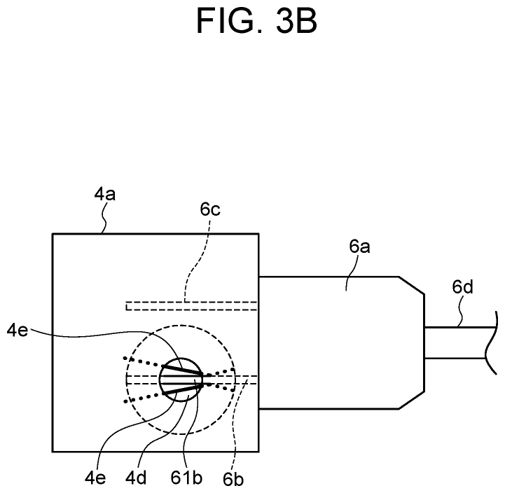

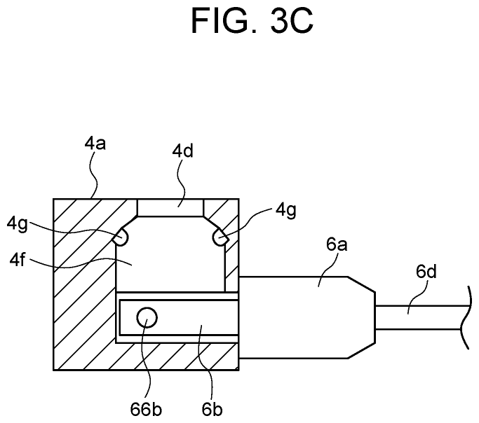

FIG. 3A is an external perspective view showing an example of the adapter 4. The adapter 4 has an adapter body 4a having a shape such as a rectangular parallelepiped. The adapter body 4a is provided with insertion ports 4b and 4c for inserting the blades 6b and 6c of the power plug 6, and an opening 4d as a mount mechanism for mounting the camera 3.

FIG. 3B is a view of the adapter 4 seen from a side on which the opening 4d is formed. FIG. 3B shows a state in which the blades 6b and 6c of the power plug 6 are inserted into the insertion ports 4b and 4c of the adapter 4. A positional relation between the insertion port 4b and the opening 4d are previously determined so that when the blades 6b and 6c of the power plug 6 are inserted completely to the roots into the insertion ports 4b and 4c, a predetermined position of the side face 61b of the one blade 6b is located directly below the opening 4d. For example, assuming that the predetermined position is a position of almost two thirds of the blade length of 17 mm from the root of the blade 6b, the center of the opening 4d is set immediately above a position of 11.3 mm deep from the entrance of the insertion port 4b. Reference numeral 4e in FIG. 3B denotes a blade holder that holds the blade 6b. The blade holder 4e has the same structure as a blade holder provided in the power outlet, and is provided in each of the insertion ports 4b and 4c. The blade holder 4e may have a projection at a position of 11.7 mm from the entrance of the insertion port 4b. When the power plug 6 is fully inserted to the end, the projection enters the blade holding hole 66b of the blade 6b, which can give a tactile notification that the power plug 6 is inserted to the end and can prevent the power plug 6 from slipping off from the adapter 4 due to the weight of the cord 6d after the power plug is inserted.

FIG. 3C is a cross-section view showing an example of an internal structure of the adapter 4. As shown in FIG. 3C, a chamber 4f is formed directly below the opening 4d of the adapter 4. The chamber 4f has, for example, a dome shape, and a top portion thereof communicates with the opening 4d. A lower part of the chamber 4f communicates with the insertion outlet 4b. When the blades 6b and 6c of the power plug 6 are inserted into the insertion ports 4b and 4c of the adapter 4 as shown in FIG. 3C, the blade 6b of the power plug 6 enters the inside of the chamber 4f Then, when the blade 6b is fully inserted to the end, the predetermined position of the side face 61b of the blade 6b is located directly below the opening 4d as described above. Therefore, when the camera 3 is attached to the opening 4d of the adapter 4, the camera 3 can capture an image of the predetermined position of the side face 61b of the blade 6 from directly above. The adapter 4 may further include an optical system (not shown) provided on an optical axis of a lens of the camera 3 attached to the opening 4d.

A light source 4g such as an LED is provided on the inner wall surface of the chamber 4f Although two light sources 4g are shown in FIG. 3C, three or more light sources may be provided. For example, eight light sources may be provided at eight points in a circumferential direction at a predetermined height. These light sources 4g irradiate the predetermined position of the side face 61b of the blade 6b located directly below the opening 4d from directions that are different from the normal direction of the side face 61b. Illumination conditions such as the irradiation direction and illuminance of the light source 4g are determined in advance so that a random pattern due to the fine irregularities on the surface of the blade 6b can be captured with appropriate quality. As electric power for driving the light source 4g, a battery (not shown) built in the adapter main body 4a is used. Alternatively, an external power source may be used to drive the light source 4g. Moreover, the light source 4g can be manually turned on or turned off by a switch that is not shown. Alternatively, the light source 4g may be configured so that it can be controlled to turn on and turn off by remote control from outside.

When the blades 6c and 6b of the power plug 6 are completely inserted into the insertion outlets 4b and 4c of the adapter 4 with the orientation of the power plug 6 shown in FIGS. 3B and 3C turned upside down, a predetermined position of the side face 62c of the blade 6c is located immediately below the opening 4d. Therefore, an image of the predetermined position of the side face 62c of the blade 6c can be captured from immediately above by using the camera 3 attached to the opening 4d of the adapter 4. Thus, with the adapter 4 in this example embodiment, it is possible, by turning the insertion orientation of the power plug 6 upside down, to capture both an image of the surface of the side face 61b of the one blade 6b and an image of the surface of the side face 62c of the other blade 6c corresponding to the side face 61b with the camera.

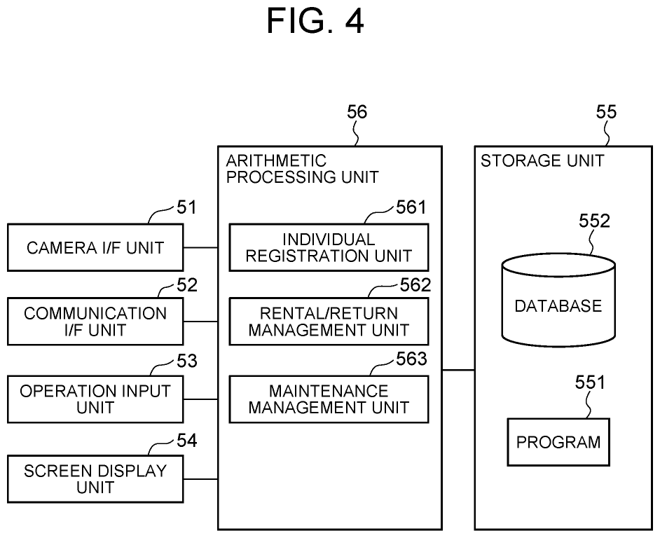

FIG. 4 is a block diagram showing an example of a configuration of the management device 5. Referring to FIG. 4, the management device 5 includes a camera I/F (interface) unit 51, a communication I/F unit 52, an operation input unit 53, a screen display unit 54, a storage unit 55, and an arithmetic processing unit 56.

The camera I/F unit 51 is connected to the camera 3 over wired or wireless communication, and is configured to perform transmission and reception of data between the camera 3 and the arithmetic processing unit 56. The communication I/F unit 52 is composed of a data communication circuit, and is configured to perform data communication with an external device (not shown) connected via wired or wireless communication. The operation input unit 53 is composed of an operation input device such as a keyboard and a mouse, and is configured to detect an operation by an operator and output to the arithmetic processing unit 56. The screen display unit 54 is composed of a screen display device such as an LCD (Liquid Crystal Display), and is configured to display on its screen various information such as a determination result in accordance with an instruction from the arithmetic processing unit 56.

The storage unit 55 is composed of a storage device such as a hard disk and a memory, and is configured to store processing information and a program 551 necessary for various processing in the arithmetic processing unit 56. The program 551 is a program that is loaded to and executed by the arithmetic processing unit 56 to realize various processing units, and is previously loaded from an external device or a storage medium, which are not shown, via a data input/output function such as the communication I/F unit 52 and stored in the storage unit 55. The major processing information stored in the storage unit 55 is stored in the database 552.

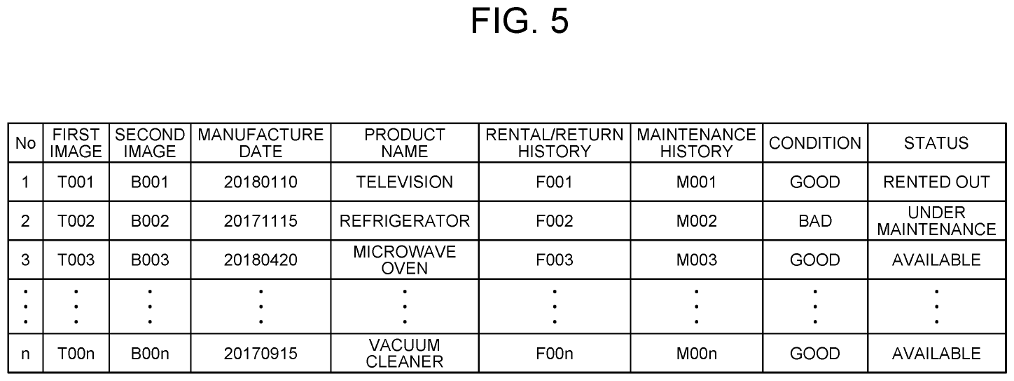

FIG. 5 shows an example of the data stored in the database 552. The database 552 has entries corresponding to electrical products on a one-to-one basis. One entry is composed of the following items; entry number, first image, second image, product name, manufacture date, rental/return history, maintenance history, condition, and status. In entry number, the serial number of an entry such as “1” is stored. In first image, an image of a predetermined position of the side face 61b of the blade 6b of the power plug 6 of the electrical product 2, such as “image T001”, is stored. In second image, an image of a predetermined position of the side face 62c of the blade 6c of the power plug 6 of the electrical product 2, such as “image B001”, is stored. In product name, the product name of the electrical product 2, such as “television”, is stored. In manufacture date, the manufacture date of the electrical product 2, such as “20180110”, is stored. In rental/return history, data relating to rental such as “F001” is stored when the electrical product 2 is rented out to a customer, and data relating to return is stored when the electrical product 2 is returned. In maintenance history, data relating to maintenance such as “M001” is stored when the maintenance of the electrical product 2 is performed. In condition, the condition of the electrical product 2 such as “good” or “bad” is recorded. In status, the status of the electrical product 2 such as “rented out”, “under maintenance”, or “available” is stored.

Referring to FIG. 4 again, the arithmetic processing unit 56 has a processor such as an MPU and its peripheral circuits, and is configured to load the program 551 from the storage unit 55 and execute to thereby make the above hardware and the program 551 cooperate with each other and realize various processing units. Major processing units realized by the arithmetic processing unit 56 are an individual registration unit 561, a rental/return management unit 562, and a maintenance management unit 563.

The individual registration unit 561 is configured to previously register data relating to the individual electrical product 2 to be rented out into the database 552.

The rental/return management unit 562 is configured to record and manage data relating to rental/return of the electrical product 2 in the database 552.

The maintenance management unit 563 is configured to record and manage data relating to maintenance of the electrical product 2 in the database 552.

Next, an operation of the electrical product management system 1 according to this example embodiment will be described.

First, an operation of previously registering data relating to the individual electrical product 2 to be rented into the database 552 will be described.

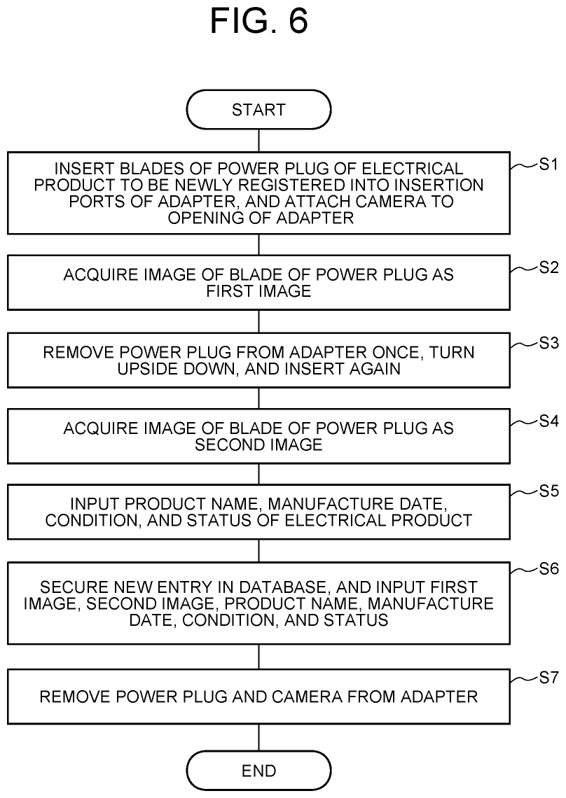

FIG. 6 is a flowchart showing an example of a procedure for previously registering data relating to the individual electrical product 2 to be rented into the database 552.

When the operator inputs an instruction to perform individual registration from the operation input unit 53, the individual registration unit 561 is activated. First, the individual registration unit 561 inserts the blades 6b and 6c of the power plug 6 of the electrical product 2 to be newly registered into the insertion ports 4b and 4c of the adapter 4, and attaches the camera 3 to the opening 4d of the adapter 4. (step S1). It is possible to make the operator manually perform this operation, for example, by displaying a necessary operation procedure on the screen display unit 54.

Next, the individual registration unit 561 captures an image of a predetermined position of the side face 61b of the blade 6b of the power plug 6 having entered the chamber 4f of the adapter 4 as shown in FIGS. 3B and 3C with the camera 3 in a state where the light source 4g of the adapter 4 is turned on, and acquires the image as a first image (step S2). It is possible to make the operator manually perform this operation, for example, by displaying a necessary operation procedure on the screen display unit 54.

Next, the individual registration unit 561 removes the power plug 6 from the adapter 4 once, turns the power plug 6 upside down, and inserts the blades 6b and 6c of the power plug 6 into the insertion ports 4c and 4b of the adapter 4 (step S3). It is possible to make the operator manually perform this operation, for example, by displaying a necessary operation procedure on the screen display unit 54.

Next, the individual registration unit 561 captures an image of a predetermined position of the side face 62c of the blade 6c of the power plug 6 having entered the chamber 4f of the adapter 4 with the camera 3 in a state where the light source 4g is turned on, and acquires the image as a second image (step S4). It is possible to make the operator manually perform this operation, for example, by displaying a necessary operation procedure on the screen display unit 54.

Next, the individual registration unit 561 inputs the product name, manufacture date, condition, and status of the electrical product from outside through the operation input unit 53 or the communication I/F unit 52 (step S5).

Next, the individual registration unit 561 secures a new entry in the database 552, and inputs the first image acquired at step S2, the second image acquired at step S4, and the product name, manufacture date, condition, and status of the electrical product input at step S5 into the secured entry (step S6). Moreover, at step S6, the individual registration unit 561 sets an automatically numbered serial number in the above entry, and sets rental/return history and maintenance history to, for example, NULL values.

Next, the individual registration unit 561 turns off the light source 4g, and removes the power plug 6 and the camera 3 from the adapter 4 (step S7). It is possible to make the operator manually perform this operation, for example, by displaying a necessary operation procedure on the screen display unit 54.

Then, the individual registration unit 561 ends the registration process for the electrical product 2 to be newly registered. After that, the electrical product 2 is carried to a predetermined storage place and stored. When there is another electrical product to be registered as an individual, the same operation as described above is repeated for the other electric product.

Next, an operation to register and manage data relating rental/return of the electrical product 2 in the database 552 will be described.

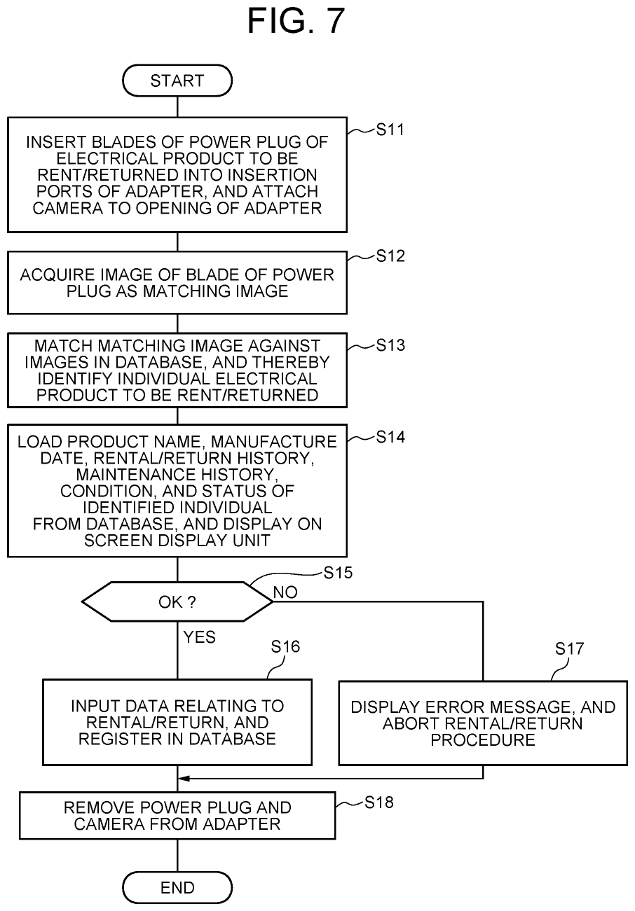

FIG. 7 is a flowchart showing an example of a procedure for recording and managing data relating to rental/return of the electrical product 2 in the database 552.

When the operator inputs an instruction to perform rental/return registration from the operation input unit 53, the rental/return management unit 562 is activated. First, the rental/return management unit 562 inserts the blades 6b and 6c of the power plug 6 of the electrical product 2 to be rented/returned into the insertion ports 4b and 4c of the adapter 4, and attaches the camera 3 to the opening 4d of the adapter 4 (step S11). It is possible to make the operator manually perform this operation, for example, by displaying a necessary operation procedure on the screen display unit 54.

Next, the rental/return management unit 562 captures an image of a predetermined position of the side face 61b of the blade 6b or the side face 62c of the blade 6c of the power plug 6 having entered the chamber 4f of the adapter 4 with the camera 3 in a state where the light source 4g is turned on, and acquires the image as a matching image (step S12). It is possible to make the operator manually perform this operation, for example, by displaying a necessary operation procedure on the screen display unit 54. It is determined by the orientation of the inserted power plug 6 whether an image of the side face 61b of the blade 4b or an image of the side face 62c of the blade 4c is captured.

Next, the rental/return management unit 562 matches the matching image against the first images and the second images of all the entries in the database 552, and thereby identifies the individual electrical product 2 to be registered to rent or return (step S13). That is to say, the rental/return management unit 562 identifies an electrical product registered in an entry including a first image or a second image that is the most similar to the matching image, as the electrical product to be registered to rent or return. Next, the rental/return management unit 562 loads the product name, manufacture date, rental/return history, maintenance history, condition, and status of the identified electrical product, from the database 552, and displays on the screen display unit 54 (step S14). The operator checks the data displayed on the screen display unit 54, and inputs an OK instruction if no problem and an NG instruction if any problem from an external terminal through the operation input unit 53 or the communication I/F unit 52 (step S15).

When the OK instruction is input, the rental/return management unit 562 inputs data relating to rental/return from an external terminal through the operation input unit 53 or the communication I/F unit 52, and registers into the entry of the identified electrical product of the database 552 (step S16). Data relating to rental includes, for example, rental date, rental term, rental fee, borrower's name, and the like, and they are additionally registered into the rental/return history. Data relating to return includes, for example, return date, and the like, and they are additionally registered into the rental/return history. Moreover, status is updated to “rented” when rented, and status is updated to “available” when returned. Next, the rental/return management unit 562 removes the power plug 6 and the camera 3 from the adapter 4 (step S18). It is possible to make the operator manually perform this operation, for example, by displaying a necessary operation procedure on the screen display unit 54. After that, the electrical product 2 is conveyed to the borrower in the case of rental, and carried to and stored in a predetermined storage place in the case of return.

Further, when the NG instruction is input, the rental/return management unit 562 displays an error message on the screen display unit 54, and aborts the rental/return procedure (step S17), proceeds to step S18, and ends the processing shown in FIG. 7.

Next, an operation to record and manage data relating to maintenance of the electrical product 2 in the database 552 will be described.

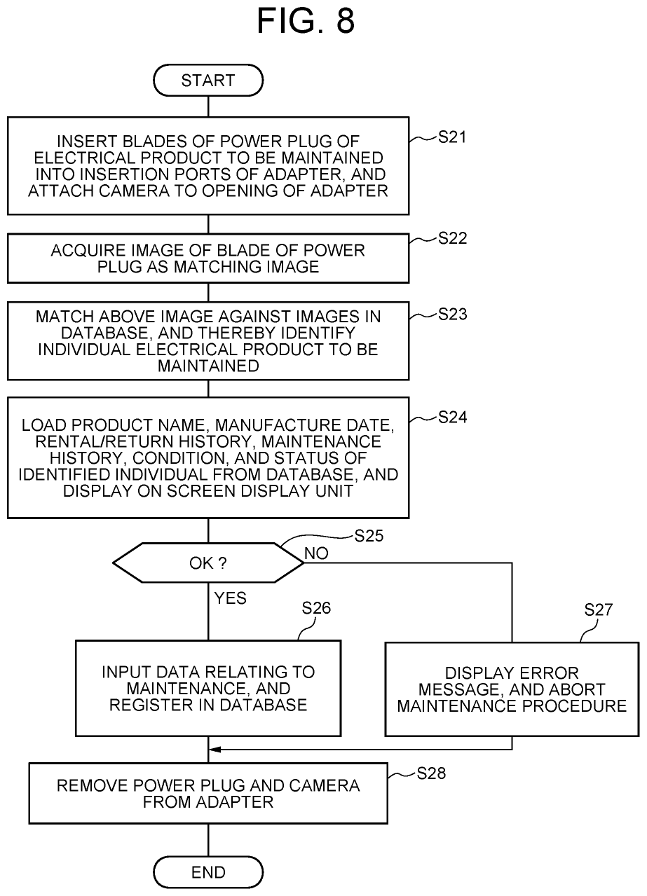

FIG. 8 is a flowchart showing an example of a procedure for recording and managing data relating to maintenance of the electrical product 2 in the database 552. Below, an example of registering data relating to maintenance at a time point when the maintenance ends will be shown. A case of registering data relating to maintenance at a time point when the maintenance starts may also be possible.

When the operator inputs an instruction to perform maintenance registration from the operation input unit 53, the maintenance management unit 563 is activated. First, the maintenance management unit 563 inserts the blades 6b and 6c of the power plug 6 of the electrical product 2 to be maintained into the insertion ports 4b and 4c of the adapter 4, and attaches the camera 3 to the opening 4d of the adapter 4 (step S21). It is possible to make the operator manually perform this operation, for example, by displaying a necessary operation procedure on the screen display unit 54.

Next, the maintenance management unit 563 captures an image of a predetermined position of the side face 61b of the blade 6b or the side face 62c of the blade 6c of the power plug 6 having entered the chamber 4f of the adapter 4 with the camera 3 in a state where the light source 4g is turned on, and acquires the image as a matching image (step S22). It is possible to make the operator manually perform this operation, for example, by displaying a necessary operation procedure on the screen display unit 54. It depends on the orientation of the power plug 6 when inserted whether an image of the side face 61b of the blade 6b or an image of the side face 62c of the blade 6c is captured.

Next, the maintenance management unit 563 matches the matching image against the first images and the second images of all the entries in the database 552, and thereby identifies the individual electrical product 2 to be registered to maintain (step S23). That is to say, the maintenance management unit 563 identifies an electrical product registered in an entry including a first image or a second image that is the most similar to the matching image, as the electrical product to be registered to maintain. Next, the maintenance management unit 563 loads the product name, manufacture date, rental/return history, maintenance history, condition, and status of the identified electrical product, from the database 552, and displays on the screen display unit 54 (step S24). The operator checks the data displayed on the screen display unit 54, and inputs an OK instruction if no problem and an NG instruction if any problem from an external terminal through the operation input unit 53 or the communication I/F unit 52 (step S25).

When the OK instruction is input, the maintenance management unit 563 inputs data relating to maintenance from an external terminal through the operation input unit 53 or the communication I/F unit 52, and registers into the entry of the identified electrical product of the database 552 (step S26). Data relating to maintenance includes a maintenance result, and the like, and they are additionally registered into the maintenance history. In a case where the condition is improved by the maintenance, condition is updated. Moreover, status is updated from “under maintenance” to “available” when the maintenance ends. Next, the maintenance management unit 563 turns off the light source 4g and removes the power plug 6 and the camera 3 from the adapter 4 (step S28). It is possible to make the operator manually perform this operation, for example, by displaying a necessary operation procedure on the screen display unit 54. After that, the electrical product 2 is carried to and stored in a predetermines storage place.

Further, when the NG instruction is input, the maintenance management unit 563 displays an error message on the screen display unit 54, aborts the maintenance registration procedure (step S27), proceeds to step S28, and ends the processing shown in FIG. 8.

As described above, according to this example embodiment, it is possible to decrease the cost for identification and management of electrical products. The reason is that an individual electrical product is authenticated based on an image of the surface of a blade of a power plug of the electrical product, and there is no need to provide a power plug with a wireless chip or an IC tag.

### Second Example Embodiment

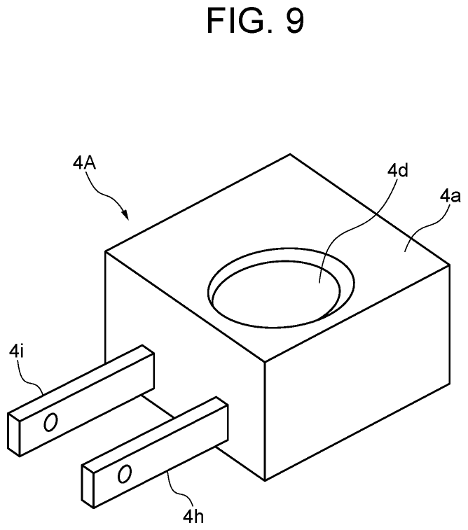

FIG. 9 is an external perspective view showing another configuration example of the adapter 4 used in the electrical product management system according to the present invention. Referring to FIG. 9, an adapter 4A according to this example embodiment is different in having a pair of blades 4h and 4i from the adapter 4 shown in FIG. 3A that does not have such blades 4h or 4i, and is otherwise the same as the adapter 4.

The blades 4h and 4i are the same ones as the blades 6b and 6c of the power plug 6, and are used in a state of being inserted into insertion ports of a power outlet (not shown). The blades 4h and 4i are electrically connected to insertion ports 4b and 4c in an adapter body 4a. For example, the blades 4h and 4i are electrically connected to blade holders provided in the insertion ports 4b and 4c.

When the blades 6b and 6c of the power plug 6 are inserted into the insertion ports 4b and 4c of the adapter 4A, which are not shown in FIG. 9, and the blades 4h and 4i of the adapter 4A are inserted into a power outlet, the power outlet and the power plug 6 are electrically connected. That is to say, the adapter 4A functions as a power strip. By attaching the camera 3 to the adapter 4A in this state, it is possible to acquire an image of the blade of the power plug 6 in a state where power is supplied from the power outlet to the electrical product 2. With this, in the case of supplying power from the power outlet to the electrical product 2 from which an image of the blade is to be acquired, it is possible to save the time and effort of inserting and removing the power plug 6.

### Third Example Embodiment

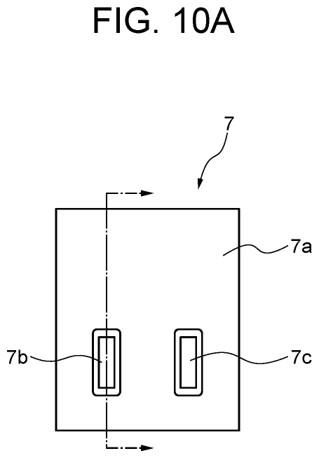

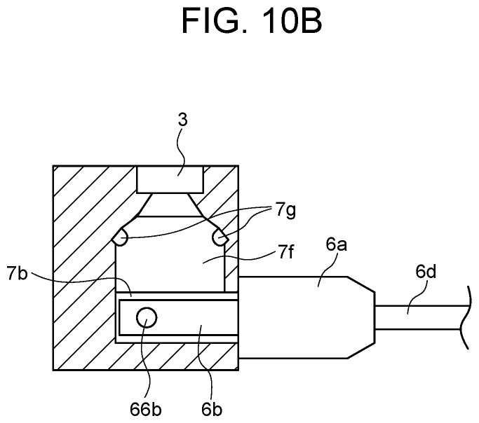

FIG. 10A is a plan view showing a configuration example of a power outlet 7 used in the electrical product management system according to the present invention. The power outlet 7 has an outlet body 7a having a shape such as a rectangular parallelepiped. The outlet body 7a is provided with insertion ports 7b and 7c for inserting the blades 6b and 6c of the power plug 6.

FIG. 10B is a cross-section view showing an example of a structure of the inside of the power outlet 7. As shown in FIG. 10B, a chamber 7f communicating with the insertion port 7b is formed in the outlet body 7a. The chamber 4f has, for example, a dome shape, and the camera 3 is attached to a top portion thereof. A lower part of the chamber 7f communicates with the insertion port 7b. When the blades 6b and 6c of the power plug 6 are fully inserted to the end in the insertion ports 7b and 7c of the power outlet 7, a predetermined position of the side face 61b of the blade 6b is located directly below the camera 3. For example, assuming that the predetermined position is a position of almost two thirds of the blade length of 17 mm from the root of the blade 6b, the camera 3 is attached immediately above a position of 11.3 mm deep from the entrance of the insertion port 7b. With this, it is possible to capture an image of the predetermined position of the side face 61b of the blade 6b with the camera 3 from immediately above.

A light source 7g such as an LED is provided on the inner wall surface of the chamber 7f Although two light sources 7g are shown in FIG. 10B, three or more light sources may be provided. For example, eight light sources may be provided at eight points in a circumferential direction at a predetermined height. These light sources 7g irradiate the predetermined position of the side face 61b of the blade 6b fully inserted to the end from directions that are different from the normal direction of the side face 61b. Illumination conditions such as the irradiation direction and illuminance of the light source 7g are determined in advance so that a random pattern due to the fine irregularities on the surface of the blade 6b can be captured with appropriate quality. As power for driving the light source 7g and the camera 3, electric power after concerting AC power connected to the power outlet 7 to DC power may be used. Moreover, the light source 7g can be turned on or turned off by operating a switch that is not shown.

When the power plug 6 is inserted into the power outlet 7, electric power is supplied from the power outlet to the electrical product 2. In this state, an image of the blade of the power plug 6 can be acquired with the camera 3. Therefore, in the case of supplying electric power from the power outlet to the electrical product 2 from which an image of the blade is to be acquired, it is possible to save the time and effort of inserting and removing the power plug 6. The power outlet 7 may have a switch to turn on/off power supply to the insertion ports 7b and 7c in accordance with a control signal from outside. In this case, the management device 5 may be configured to perform matching of an image of the blade of the power plug 6 acquired with the camera 3 against previously registered images, and allow power supply to the electrical product by turning on the switch when the matching succeeds, whereas prevent power supply by turning off the switch when the matching fails.

Further, in a case where the management device 5 is a home server or the like, the user can turn on/off power supply by remote control to an electrical product which does not have a remote control function like IoT without modifying the product. To be specific, the management device 5 previously stores a correspondence relation between an image of the blade of the power plug 6 of the electrical product 2 used at home and the identification name of the electrical product 2 (for example, a correspondence relation between first/second images and product name in FIG. 5) as a correspondence table. Moreover, the management device 5 acquires an image of the blade of the power plug 6 of the electrical product 2 connected to the power outlet 7 with the camera 3, matches the acquired image against the images listed on the above correspondence table, detects the identification name of the electrical product 2 connected to the power outlet 7, and stores a correspondence relation between the identification name of the electrical product 2 and the identification name of the power outlet 7 to which the electrical product 2 is connected into a control table. Then, upon receiving a command including the identification name of the electrical product 2 and an ON instruction or an off instruction from the user's mobile terminal such as a smartphone, the management device 5 refers to the control table and identifies the power outlet 7 to which the electrical product 2 having the identification name indicated by the command is connected. In the case of an ON instruction, the management device 5 turns on the abovementioned switch (the switch that turns on/off the power supply to the insertion ports 7b and 7c of the power outlet 7) to allow power supply to the electrical product. In the case of an OFF instruction, the management device 5 turns off the above switch to stop the power supply.

### Fourth Example Embodiment

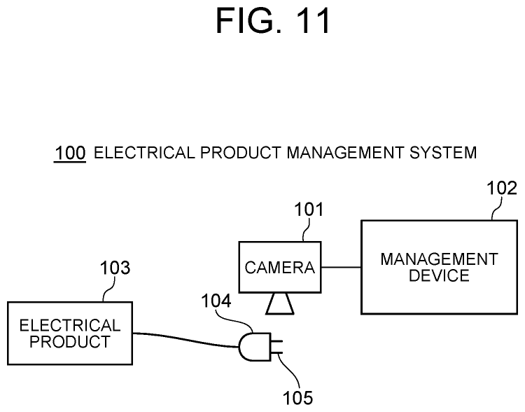

FIG. 11 is a configuration view of an electrical product management system 100 according to a fourth example embodiment of the present invention. The electrical product management system 100 is a system that identifies and manages an individual electrical product 103. The electrical product management system 100 includes a camera 101 and a management device 102.

The camera 101 is configured to acquire an image of the surface of a blade 105 of a power plug 104 of the electrical product 103. The camera 101 can be configured, for example, in the same manner as the camera 3 of FIG. 1, but is not limited thereto.

The management device 102 is configured to authenticate the individual electrical product 103 based on an image acquired by the camera 101. The management device 102 can be configured, for example, in the same manner as the management device 5 of FIG. 1, but is not limited thereto.

The electrical product management system 100 thus configured operates in the following manner. First, the camera 101 acquires an image of the surface of the blade 105 of the power plug 104 of the electrical product 103. Next, the management device 102 authenticates the individual electrical product 103 based on the image acquired by the camera 101.

Thus, the electrical product management system 100 according to this example embodiment enables decrease of the cost for identification and management of an electrical product. The reason is that an individual product is authenticated based on an image of a surface of a blade of a power plug of an electrical product and there is no need to provide the power plug with a wireless chip or an IC tag.

### Other Example Embodiment

Although the present invention has been described above with reference to the example embodiments, the present invention is not limited to the above example embodiments. The configurations and details of the present invention can be changed in various manners that can be understood by one skilled in the art within the scope of the present invention. For example, the present invention also includes the following.

In the above example embodiments, images of the surfaces of the narrow-width side faces 61c and 62b of the blades 6b and 6c of the power plug 6, but the side faces of the blades where images are acquired are not limited thereto. For example, an image may be acquired from one or more of broad-width side faces 63b, 63c, 64b and 64c and side faces 65b and 65c of the tip end.

In the above example embodiments, the power plug 6 is a flat blade type having no distinction between polarities, but the type of the power plug is not limited thereto. The power plug targeted by the present invention is applicable to all power plugs specified in the Japanese Industrial Standards (JIS C8303: 2007), such as a flat blade type having a distinction between polarities, a hook type having a curved blade in an arc, and a power plug having a grounding electrode. Moreover, in a case where a plurality of types of power plugs 6 having different formats are included, a plurality of types of adapters corresponding thereto may be used.

Further, in the above example embodiments, two images including an image of the side face 61b of the blade 6b and an image of the side face 62c of the blade 6c are acquired as first and second images and registered into a database at the time of registration of the power plug 6, and an image of either the side face 61b of the blade 6b or the side face 62c of the blade 6c is acquired as a matching image and the matching image is matched against the first and second images at the time of matching of the power plug 6, but the processing is not limited thereto. For example, an image of either the side face 61b of the blade 6b or the side face 62c of the blade 6c may be acquired as a registration image and registered into a database at the time of registration of the power plug 6, and two images including an image of the side face 61b of the blade 6b and an image of the side face 62c of the blade 6c may be acquired as first and second images and the first and second images may be matched against all the registered images at the time of matching of the power plug 6. Alternatively, both at the time of registration of the power plug 6 and at the time of matching of the power plug 6, two images including an image of the side face 61b of the blade 6b and an image of the side face 61c of the blade 6c may be acquired as first and second registration images and as first and second matching images, and the first and second matching images may be matched against the first and second registration images in a database. Alternatively, both at the time of registration of the power plug 6 and at the time of matching of the power plug 6, an image of either the side face 61b of the blade 6b or the side face 62c of the blade 6c may be acquired as a registration image and a matching image, and the matching image may be matched against all the registration images in a database.

Further, in the above example embodiments, an image of a blade is registered and matched, but a feature value that characterizes a fine pattern may be extracted, and the extracted feature value may be registered and matched instead of an image.

The present invention can be utilized in all fields of an electrical product management system that identifies and manages an individual electrical product, such as a system for renting an electrical product to a customer.

The whole or part of the example embodiments disclosed above can be described as, but not limited to, the following supplementary notes.

### [Supplementary Note 1]

An electrical product management system identifying and managing an individual electrical product, the electrical product management system comprising:

a camera configured to acquire an image of a surface of at least one blade of a plurality of blades included by a power plug of the electrical product; and

a management device configured to authenticate the individual electrical product based on the image.

### [Supplementary Note 2]

The electrical product management system according to Supplementary Note 1, further comprising an adapter device, wherein the adapter device includes:

an adaptor body including a plurality of insertion ports in which the plurality of blades are inserted, an opening for attaching the camera, and a chamber communicating with the insertion ports and the opening; and

a light source installed in the chamber and configured to emit light to a position in which a predetermined site of one blade of the plurality of blades fully inserted into the plurality of insertion ports is located.

### [Supplementary Note 3]

The electrical product management system according to Supplementary Note 2, wherein the opening is formed immediately above the position.

### [Supplementary Note 4]

The electrical product management system according to Supplementary Note 2 or 3, wherein the adaptor body has a plurality of blades to be inserted into a power outlet and the plurality of blades are electrically connected to the plurality of insertion ports.

### [Supplementary Note 5]

The electrical product management system according to any of Supplementary Notes 1 to 4, wherein the camera is configured to acquire an image of a surface of any one side face of total five side faces of top, bottom, left, right, and tip portions of one blade of two blades included by the power plug.

### [Supplementary Note 6]

The electrical product management system according to any of Supplementary Notes 1 to 5, wherein the management device is configured to authenticate the individual electrical product based on the image and a previously registered image acquired from at least one blade of a plurality of blades included by a power plug of a registration target electrical product.

### [Supplementary Note 7]

The electrical product management system according to Supplementary Note 6, wherein the registered image includes a first registered image and a second registered image, the first registered image being an image of a surface of a specific side face that is any one side face of total five side faces of top, bottom, left, right, and tip portions of one blade of two blades included by the power plug of the registration target electrical product, the second registered image being an image of a surface of a corresponding side face to the specific side face of total five side faces of top, bottom, left, right, and tip portions of another blade of the two blades included by the power plug of the registration target electrical product.

### [Supplementary Note 8]

The electrical product management system according to Supplementary Note 6 or 7, wherein the management device is configured to manage information relating to the authenticated electrical product.

### [Supplementary Note 9]

The electrical product management system according to Supplementary Note 8, wherein the management device is configured to record and manage data relating to rental and return of the authenticated electrical product in a database.

### [Supplementary Note 10]

The electrical product management system according to Supplementary Note 8, wherein the management device is configured to record and manage data relating to maintenance of the authenticated electrical product in a database.

### [Supplementary Note 11]

The electrical product management system according to Supplementary Note 1, further comprising a power outlet, wherein:

the power outlet includes a light source configured to emit light to a position in which a predetermined site of one blade of the plurality of blades fully inserted into a plurality of insertion ports of the power outlet is located; and

a camera is attached to the power outlet so as to capture the position.

### [Supplementary Note 12]

An electrical product management method for identifying and managing an individual electrical product, the electrical product management method comprising:

acquiring an image of a surface of at least one blade of a plurality of blades included by a power plug of the electrical product; and

authenticating the individual electrical product based on the image.

### [Supplementary Note 13]

The electrical product management method according to Supplementary Note 12, wherein the acquiring the image is performed in a state of attaching a camera to an opening of an adaptor device and inserting the plurality of blades into a plurality of insertion ports of an adaptor body of the adaptor device, the adaptor device including: the adaptor body including the plurality of insertion ports in which the plurality of blades are inserted, the opening for attaching the camera, and a chamber communicating with the insertion ports and the opening; and a light source installed in the chamber and configured to emit light to a position in which a predetermined site of one blade of the plurality of blades fully inserted into the plurality of insertion ports is located.

### [Supplementary Note 14]

The electrical product management method according to Supplementary Note 13, wherein the opening is formed immediately above the position.

[Supplementary Note 15] The electrical product management method according to Supplementary Note 13 or 14, wherein the adaptor body has a plurality of blades to be inserted into a power outlet and the plurality of blades are electrically connected to the plurality of insertion ports.

### [Supplementary Note 16]

The electrical product management method according to any of Supplementary Notes 12 to 15, comprising acquiring with the camera an image of a surface of any one side face of total five side faces of top, bottom, left, right, and tip portions of one blade of two blades included by the power plug.

### [Supplementary Note 17]

The electrical product management method according to any of Supplementary Notes 12 to 16, comprising authenticating the individual electrical product based on the image and a previously registered image acquired from at least one blade of a plurality of blades included by a power plug of a registration target electrical product.

### [Supplementary Note 18]

The electrical product management method according to Supplementary Note 17, wherein the registered image includes a first registered image and a second registered image, the first registered image being an image of a surface of a specific side face that is any one side face of total five side faces of top, bottom, left, right, and tip portions of one blade of two blades included by the power plug of the registration target electrical product, the second registered image being an image of a surface of a corresponding side face to the specific side face of total five side faces of top, bottom, left, right, and tip portions of another blade of the two blades included by the power plug of the registration target electrical product.

### [Supplementary Note 19]

The electrical product management method according to Supplementary Note 17 or 18, further comprising managing information relating to the authenticated electrical product.

### [Supplementary Note 20]

The electrical product management method according to Supplementary Note 19, wherein in the managing, data relating to rental and return of the authenticated electrical product is recorded in a database and managed.

### [Supplementary Note 21]

The electrical product management method according to Supplementary Note 19, wherein in the managing, data relating to maintenance of the authenticated electrical product is recorded in a database and managed.

[Supplementary Note 22] The electrical product management method according to Supplementary Note 12, wherein the acquiring the image is performed with a camera in a state of fully inserting the plurality of blades into a plurality of insertion ports of a power outlet, and emitting light from a light source installed in the power outlet to a position in which a predetermined site of one blade of the plurality of blades fully inserted into the plurality of insertion ports is located, the camera being attached to the power outlet so as to capture the position.

### [Supplementary Note 23]

A non-transitory computer-readable recording medium on which a program is recorded, the program comprising instructions for causing a computer identifying and managing an individual electrical product to execute:

a process of acquiring an image of a surface of at least one blade of a plurality of blades included by a power plug of the electrical product; and

a process of authenticating the individual electrical product based on the image.

### [Supplementary Note 24]

An adapter device comprising:

an adaptor body including a plurality of insertion ports in which a plurality of blades included by a power plug of an electrical product are inserted, an opening for attaching a camera, and a chamber communicating with the insertion ports and the opening; and

a light source installed in the chamber and configured to emit light to a position in which a predetermined site of one blade of the plurality of blades fully inserted into the plurality of insertion ports is located.

### [Supplementary Note 25]

The electrical product management system according to any of Supplementary Notes 1 to 11, wherein the management device is configured to: store a correspondence relation between identification information of a power outlet in which the power plug of the electrical product is inserted and identification information of the electrical product; upon receiving a command including identification information of the electrical product and an instruction to turn on or off from an external terminal, identify the power outlet to which the electrical product having the identification information indicated by the command is connected based on the correspondence relation; and control a power status of the power outlet in accordance with the instruction.

### DESCRIPTION OF NUMERALS

1 electrical product management system
2 electrical product
3 camera
4 adapter
4A adapter
4a adapter body
4b, 4c insertion port
4d opening
4e blade holder
4f chamber
4g light source
4h, 4i blade
5 management device
6 power plug
6a plug body
6b, 6c blade
6d power cord
7 power outlet
7a output body
7b, 7c insertion port
7f chamber
7g light source
51 camera I/F unit
52 communication I/F unit
53 operation input unit
54 screen display unit
55 storage unit
56 arithmetic processing unit
61b, 62b, 63b, 64b, 65b, 61c, 62c, 63c, 64c, 65c side face
66b, 66c blade holding hole
100 electrical product management system
101 camera
102 management device
103 electrical product
104 power plug
105 blade
551 program
552 database
561 individual registration unit
562 rental/return management unit
563 maintenance management unit

What is claimed is:

1. An electrical product management system identifying and managing an individual electrical product, the electrical product management system comprising:
a camera configured to acquire an image of a surface of at least one blade of a plurality of blades included by a power plug of the electrical product; and
a management device configured to authenticate the individual electrical product based on the image.

2. The electrical product management system according to claim 1, further comprising an adapter device, wherein the adapter device includes:
an adaptor body including a plurality of insertion ports in which the plurality of blades are inserted, an opening for attaching the camera, and a chamber communicating with the insertion ports and the opening; and
a light source installed in the chamber and configured to emit light to a position in which a predetermined site of one blade of the plurality of blades fully inserted into the plurality of insertion ports is located.

3. The electrical product management system according to claim 2, wherein the opening is formed immediately above the position.

4. The electrical product management system according to claim 2, wherein the adaptor body has a plurality of blades to be inserted into a power outlet and the plurality of blades are electrically connected to the plurality of insertion ports.

5. The electrical product management system according to claim 1, wherein the camera is configured to acquire an image of a surface of any one side face of total five side faces of top, bottom, left, right, and tip portions of one blade of two blades included by the power plug.

6. The electrical product management system according to claim 1, wherein the management device is configured to authenticate the individual electrical product based on the image and a previously registered image acquired from at least one blade of a plurality of blades included by a power plug of a registration target electrical product.

7. The electrical product management system according to claim 6, wherein the registered image includes a first registered image and a second registered image, the first registered image being an image of a surface of a specific side face that is any one side face of total five side faces of top, bottom, left, right, and tip portions of one blade of two blades included by the power plug of the registration target electrical product, the second registered image being an image of a surface of a corresponding side face to the specific side face of total five side faces of top, bottom, left, right, and tip portions of another blade of the two blades included by the power plug of the registration target electrical product.

8-10. (canceled)

11. The electrical product management system according to claim 1, further comprising a power outlet, wherein:
the power outlet includes a light source configured to emit light to a position in which a predetermined site of one blade of the plurality of blades fully inserted into a plurality of insertion ports of the power outlet is located; and
a camera is attached to the power outlet so as to capture the position.

12. An electrical product management method for identifying and managing an individual electrical product, the electrical product management method comprising:
acquiring an image of a surface of at least one blade of a plurality of blades included by a power plug of the electrical product; and
authenticating the individual electrical product based on the image.

13. The electrical product management method according to claim 12, wherein the acquiring the image is performed in a state of attaching a camera to an opening of an adaptor device and inserting the plurality of blades into a plurality of insertion ports of an adaptor body of the adaptor device, the adaptor device including: the adaptor body including the plurality of insertion ports in which the plurality of blades are inserted, the opening for attaching the camera, and a chamber communicating with the insertion ports and the opening; and a light source installed in the chamber and configured to emit light to a position in which a predetermined site of one blade of the plurality of blades fully inserted into the plurality of insertion ports is located.

14. The electrical product management method according to claim 13, wherein the opening is formed immediately above the position.

15. The electrical product management method according to claim 13, wherein the adaptor body has a plurality of blades to be inserted into a power outlet and the plurality of blades are electrically connected to the plurality of insertion ports.

16. The electrical product management method according to claim 12, comprising acquiring with the camera an image of a surface of any one side face of total five side faces of top, bottom, left, right, and tip portions of one blade of two blades included by the power plug.

17. The electrical product management method according to claim 12, comprising authenticating the individual electrical product based on the image and a previously registered image acquired from at least one blade of a plurality of blades included by a power plug of a registration target electrical product.

18. The electrical product management method according to claim 17, wherein the registered image includes a first registered image and a second registered image, the first registered image being an image of a surface of a specific side face that is any one side face of total five side faces of top, bottom, left, right, and tip portions of one blade of two blades included by the power plug of the registration target electrical product, the second registered image being an image of a surface of a corresponding side face to the specific side face of total five side faces of top, bottom, left, right, and tip portions of another blade of the two blades included by the power plug of the registration target electrical product.

19-21. (canceled)

22. The electrical product management method according to claim 12, wherein the acquiring the image is performed with a camera in a state of fully inserting the plurality of blades into a plurality of insertion ports of a power outlet, and emitting light from a light source installed in the power outlet to a position in which a predetermined site of one blade of the plurality of blades fully inserted into the plurality of insertion ports is located, the camera being attached to the power outlet so as to capture the position.

23. A non-transitory computer-readable recording medium on which a program is recorded, the program comprising instructions for causing a computer identifying and managing an individual electrical product to execute:
a process of acquiring an image of a surface of at least one blade of a plurality of blades included by a power plug of the electrical product; and
a process of authenticating the individual electrical product based on the image.

24. (canceled)

25. The electrical product management system according to claim 1, wherein the management device is configured to: store a correspondence relation between identification information of a power outlet in which the power plug of the electrical product is inserted and identification information of the electrical product; upon receiving a command including identification information of the electrical product and an instruction to turn on or off from an external terminal, identify the power outlet to which the electrical product having the identification information indicated by the command is connected based on the correspondence relation; and control a power status of the power outlet in accordance with the instruction.
